(19) United States
(12) Patent Application Publication
(10) Pub. No.: US 2012/0316662 A1
(43) Pub. Date: Dec. 13, 2012

(54) SYSTEM AND METHOD FOR PROVIDING CONTENTS THROUGH NETWORK IN DEVICE INCAPABLE OF CONNECTING TO A NETWORK

(75) Inventors: Hun Huh, Gyeonggi-do (KR); Duk Hyun Park, Seoul (KR); Hyoung Gyun Kim, Seoul (KR); Eun Bok Lee, Seoul (KR)

(73) Assignee: SK Planet Co., Ltd., Seoul (KR)

(21) Appl. No.: 13/380,077

(22) PCT Filed: Mar. 24, 2011
(86) PCT No.: PCT/KR2011/002014

§ 371 Date: Dec. 22, 2011

(30) Foreign Application Priority Data
Jul. 23, 2010 (KR) 10-2010-0071178

(51) Int. Cl. G06F 17/00

(52) U.S. Cl. 700/94

(57) ABSTRACT

The present invention relates to a system and method for providing contents through a network in a device incapable of connecting to a network, the system including a contents playback device provided with an audio output port, for playing back the contents; and a dongle device supporting CPNS and attached to the audio output port to enable the contents playback device to operate as a device capable of connecting to a network, for capturing and encoding contents outputted from the contents playback device and providing an external user terminal with the encoded contents through the network. Accordingly, according to the present invention, the contents playback device incapable of connecting to a network is enabled to operate as a device capable of connecting to a network only by attaching the dongle device, and since the dongle device encodes the contents (e.g., sound source data) outputted from the contents playback device in real-time and transfers the encoded contents to an external user terminal through the CPNS protocol, the contents can be shared between the contents playback device and the external user terminal.

### TECHNICAL FIELD

The present invention relates to a system and method for providing contents through a network in a device incapable of connecting to a network, and more specifically, to a system and method for providing contents through a network in a device incapable of connecting to a network, which enables a contents playback device to operate as a device capable of connecting to a network by attaching a dongle device to the contents playback device incapable of connecting to a network, records contents outputted in real-time through an audio output port of the contents playback device, and provides corresponding contents through short-range wireless communication if download of contents is requested by a user terminal existing in the same network.

### BACKGROUND ART

With the advancement of information communication technologies, a variety of contents playback devices capable of playing back documents, images, audios, moving pictures and the like, such as cellular phones, MPEG audio layer-3 (MP3) players, Personal Multimedia Players (PMP) and Ultra Mobile Personal Computers (UMPC), are widely used.

The contents playback devices are provided with an interface function for connecting to the Internet through a personal computer (PC) and downloading free or paid MP3 audio files provided by Internet websites.

The contents playback device downloads contents desired by a user from the PC and plays back the downloaded contents. However, there is a problem in that the desired contents cannot be downloaded if the user is moving or cannot connect to the PC.

In order to solve the problem, techniques for adding a communication means capable of connecting to a short-range wireless communication network onto the contents playback device, such as a Bluetooth or an ultra-wideband (UWB), have been proposed.

According to the techniques, it is possible to download contents from an external device through the short-range wireless communication network.

However, the conventional contents playback devices described above can share contents only when a network connection function such as Ethernet or WiFi is provided, and existing general contents playback devices cannot provide services that use converged personal network services (CPNS).

Furthermore, a contents playback device such as a radio which outputs audio data cannot record contents outputted in real-time.

### DISCLOSURE OF INVENTION

### Technical Problem

Therefore, the present invention has been made in view of the above problems, and it is an object of the present invention to provide a system and method for providing contents through a network in a device incapable of connecting to a network, in which contents outputted in real-time from a contents playback device incapable of connecting to a network can be recorded.

Another object of the present invention is to provide a system and method for providing contents through a network in a device incapable of connecting to a network, in which a contents playback device incapable of connecting to a network is enabled to operate as a device capable of connecting to a network, and the contents can be shared by encoding the contents (e.g., sound source data) outputted from the contents playback device in real-time and transferring the encoded contents to an external user terminal through the CPNS protocol.

### Technical Solution

To accomplish the above object, according to one aspect of the present invention, there is provided a system for providing contents through a network in a device incapable of connecting to a network, the system comprising: a contents playback device provided with an audio output port, for playing back the contents; and a dongle device supporting CPNS and attached to the audio output port to enable the contents playback device to operate as a device capable of connecting to a network, for capturing and encoding contents outputted from the contents playback device and providing an external user terminal with the encoded contents through the network.

The system for providing contents through a network in a device incapable of connecting to a network may further comprise a user terminal for requesting download of contents from the dongle device through the CPNS and receiving corresponding contents.

The contents playback device may operate as a device capable of connecting to a network through a wireless communication unit provided in the dongle device.

According to another aspect of the present invention, there is provided a dongle device in a system for providing contents through a network in a device incapable of connecting to a network, the dongle device comprising a stereo jack interface unit attached to an audio output port of a contents playback device, for communicating with the contents playback device; an input unit for inputting a user command; a contents capture unit for capturing contents outputted from the contents playback device through the stereo jack interface unit if a contents record command is inputted through the input unit; and an encoding unit for encoding the contents captured by the contents capture unit.

The dongle device may further comprise a wireless communication unit for performing communication through a short-range wireless communication network; and a contents extracting unit for extracting and transmitting corresponding contents to a user terminal through the wireless communication unit if download of contents is requested from the user terminal existing in the same network.

In response to the contents download request received from the user terminal, the encoding unit determines an encoding format based on terminal information on the user terminal, re-encodes corresponding contents depending on the determined encoding format, and transmits the re-encoded contents through the wireless communication unit.

If a contents recording cancel command is inputted through the input unit while capturing the contents, the contents capture unit stops capturing the contents.

According to still another aspect of the present invention, there is provided a user terminal in a system for providing contents through a network in a device incapable of connecting to a network, the user terminal comprising a wireless communication unit for performing communication through a short-range wireless communication network; a storage unit for storing contents; a device search unit for searching for a device supporting CPNS, receiving device information from the searched device, and managing the received device information; a contents-share processing unit for requesting and receiving a contents list from the device searched by the device search unit, requesting download of contents corresponding to a contents list selected by a user from the received contents list, and receiving contents of the selected contents list; and a playback unit for playing back the contents shared by the contents-share processing unit.

According to another aspect of the present invention, there is provided a method for providing contents through a network in a device incapable of connecting to a network, in which a dongle device provides contents stored in a contents playback device incapable of connecting to a network to an external user terminal through the network, the method comprising the steps of: (a) connecting to the contents playback device through an audio output port provided in the contents playback device; (b) capturing the contents outputted through the audio output port of the contents playback device if a contents record command is inputted; and (c) encoding the captured contents.

The method for providing contents through a network in a device incapable of connecting to a network may further comprise, after step (c), the step of extracting and transmitting corresponding contents to the user terminal through short-range wireless communication if download of contents is requested from the user terminal existing in the same network.

If download of contents is requested from the user terminal, an encoding format is determined based on terminal information on the user terminal, and corresponding contents are re-encoded depending on the determined encoding format and transmitted to the user terminal through the short-range wireless communication.

In step (a), the dongle device is attached to the audio output port of the contents playback device to be connected to the contents playback device, and the contents playback device operates as a device capable of connecting to a network through a wireless communication unit provided in the dongle device.

In step (b), if a contents recording cancel command is inputted while capturing the contents, capturing the contents is stopped.

### Advantageous Effects

According to the present invention described above, contents outputted in real-time from a contents playback device such as a radio can be recorded.

Furthermore, a contents playback device incapable of connecting to a network is enabled to operate as a device capable of connecting to a network only by attaching a dongle device, and since the dongle device encodes the contents (e.g., sound source data) outputted from the contents playback device in real-time and transfers the encoded contents to an external user terminal through the CPNS protocol, the contents can be shared between the contents playback device and the external user terminal.

### BRIEF DESCRIPTION OF THE DRAWINGS

FIG. 1 is a view showing a system for providing contents through a network in a device incapable of connecting to a network according to an embodiment of the present invention.

FIG. 2 is a block diagram schematically showing the configuration of a dongle device according to an embodiment of the present invention.

FIG. 3 is a block diagram schematically showing the configuration of a user terminal according to an embodiment of the present invention.

FIG. 4 is a flowchart illustrating a method for providing contents through a network in a device incapable of connecting to a network according to an embodiment of the present invention.

### BEST MODE FOR CARRYING OUT THE INVENTION

Details of the objects, technical configurations, and operational effects of the present invention described above will be further clearly understood hereinafter according to the detailed descriptions with reference to the drawings accompanied in the specification of the present invention.

The CPNS environment disclosed in the present invention is an environment in which a portable terminal capable of performing only short-range wireless communication, but incapable of performing cellular communication with mobile communication networks is allowed to use data services that can be provided through the cellular communication by performing short-range wireless communication with a mobile communication terminal that functions as a personal network service (PN) gateway.

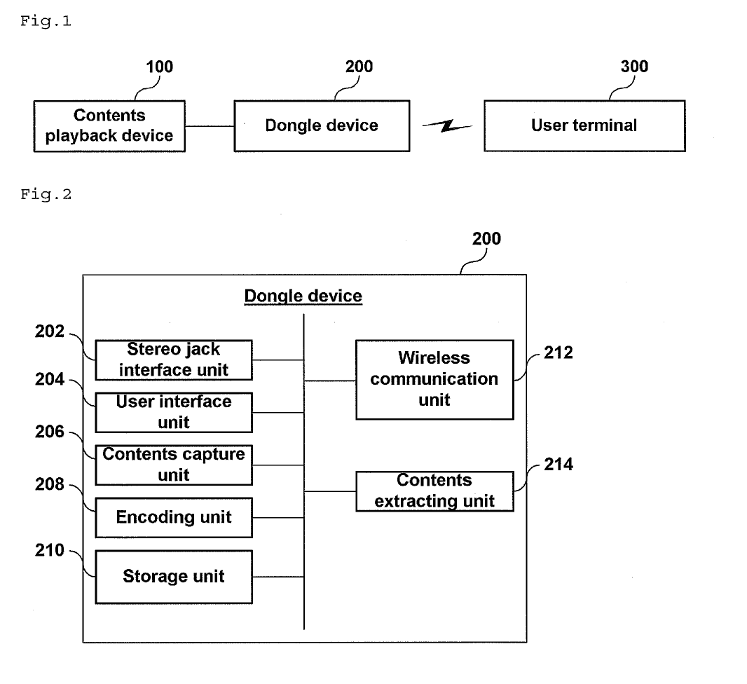

FIG. 1 is a view showing a system for providing contents through a network in a device incapable of connecting to a network according to an embodiment of the present invention.

Referring to FIG. 1, the system for providing contents through a network in a device incapable of connecting to a network includes a contents playback device 100 for playing back contents, a dongle device 200 for recording the contents outputted from the contents playback device, and a user terminal 300 supporting CPNS.

The contents playback device 100 is an MP3 player, a PMP, a UMPC, a radio or the like that can play back documents, images, audios, moving pictures and the like.

The contents playback device 100 does not support CPNS and has an audio output port (e.g., Aux In/Out), and the dongle device 200 is attached to the audio output port. Although it is expressed as an audio output port here, it can be expressed as a stereo output port or the like.

In addition, the contents playback device 100 is a device incapable of connecting to a network, and if the dongle device 200 is attached to the audio output port, the contents playback device 100 operates as a device capable of connecting to a network through a wireless communication unit provided in the dongle device 200.

The dongle device 200 enables the contents playback device 100 to operate as a device capable of connecting to a network through the connection to the audio output port of the contents playback device 100, captures and encodes contents (e.g., audio data) outputted from the contents playback device 100, and provides the external user terminal 300 with the contents through a network.

In addition, the dongle device 200 provides the user terminal with the encoded contents through short-range wireless communication in response to a request from a user terminal existing in the same network. Since the dongle device 200 is a device supporting CPNS, it includes a wireless communication unit enabling the short-range wireless communication.

In addition, the dongle device 200 includes a 3.5 stereo jack controller and the wireless communication unit and performs functions such as storing contents, providing the stored contents, and transmitting the contents. The dongle device is attached to the contents playback device 100 and performs functions such as storing contents data outputted from the contents playback device 100 and transmitting playback data outputted from the contents playback device 100 to a neighboring user terminal 300 supporting CPNS.

The dongle device 200 may be a portable device that can be attached to the contents playback device 100.

The user terminal 300 is a terminal supporting CPNS, which searches for a device for performing short-range wireless communication, and requests and receives contents from the searched dongle device 200.

The user terminal 300 is provided with a short-range wireless communication module for performing short-range wireless communication with the dongle device.

Although only one user terminal 300 is shown in the figure, there may be a plurality of user terminals supporting CPNS.

The dongle device 200 and the plurality of user terminals supporting CPNS are associated with each other as one group and transmit and receive information to and from each other through the short-range wireless communication network, and they can even communicate with a mobile communication network. Here, the short-range wireless communication network may include all kinds of communication networks capable of performing short-range wireless communication, such as WiFi, Wibro, wireless LAN, Bluetooth, UWB, and the like.

The dongle device 200 that functions as such will be described in detail with reference to FIG. 2.

The system for providing contents through a network in a device incapable of connecting to a network configured as described above enables the contents playback device 100 incapable of connecting to a network to operates as a device capable of connecting to a network only by attaching the dongle device 200.

In addition, since the dongle device 200 encodes the contents (e.g., sound source data) outputted from the contents playback device 100 in real-time and transfers the encoded contents to the external user terminal 300 through the CPNS protocol, the contents can be shared between the contents playback device 100 and the external user terminal 300.

FIG. 2 is a block diagram schematically showing the configuration of a dongle device according to an embodiment of the present invention.

Referring to FIG. 2, the dongle device 200 includes a stereo jack interface unit 202, an input unit 204, a contents capture unit 206, an encoding unit 208, a storage unit 210, a wireless communication unit 212, and a contents extracting unit 214.

The stereo jack interface unit 202 is attached to the contents playback device through a stereo jack to enable communication with the contents playback unit. The stereo jack can be a 3.5 stereo jack or the like.

In addition, although it is not shown in the figure, the dongle device 200 may include a USB module.

The input unit 204 receives a command for starting or stopping recording the contents outputted from the contents playback device.

That is, there are ‘record’ and ‘cancel record’ buttons in the input unit 204, and a user records the contents outputted from the contents playback device by pressing the ‘record’ button and stops recording the contents by pressing the ‘cancel record’ button.

If a contents record command is inputted through the input unit 204, the contents capture unit 206 captures the contents outputted from the contents playback device and received through the stereo jack interface unit 202.

In addition, if a contents recording cancel command is inputted through the input unit 204, the contents capture unit 206 stops recording the contents currently being captured.

The encoding unit 208 encodes the contents captured by the contents capture unit 206. That is, since the contents playback device outputs contents after decoding the contents, if the contents capture unit 206 captures the decoded contents, the encoding unit 208 re-encodes the captured contents.

In addition, if a contents request is received from a user terminal existing in the same network, the encoding unit 208 determined an encoding format based on terminal information on the user terminal and may re-encode corresponding contents depending on the determined encoding format.

The storage unit 210 stores the contents encoded by the encoding unit 208.

If download of contents is requested from a user terminal existing in the same network, the contents extracting unit 214 extracts corresponding contents from the storage unit 210 and transmits the extracted contents to the user terminal through the wireless communication unit 212. Here, the user terminal is a terminal supporting CPNS, and the user terminal and the dongle device communicate with each other through the short-range wireless communication network.

The wireless communication unit 212 is provided with a short-range wireless communication module for performing short-range wireless communication, such as WiFi, Wibro, wireless LAN, Bluetooth, UWB, and the like.

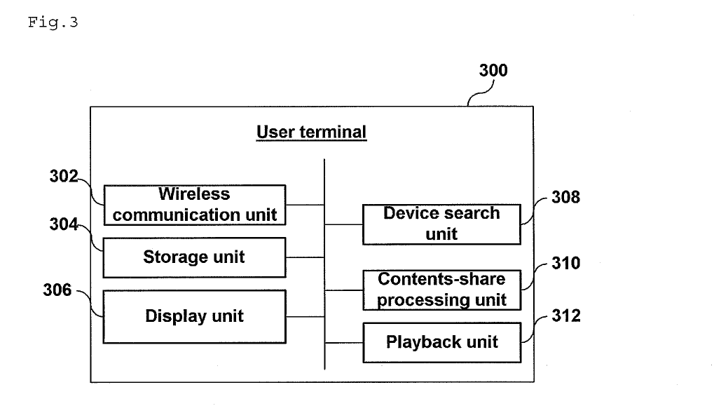

FIG. 3 is a block diagram schematically showing the configuration of a user terminal according to an embodiment of the present invention.

Referring to FIG. 3, the user terminal 300 includes a wireless communication unit 302 for performing communication through a short-range wireless communication network, a storage unit for storing contents, a display unit 306, a device search unit 308, a contents-share processing unit 310, and a playback unit 312.

The wireless communication unit 302 is provided with a short-range wireless communication module for performing short-range wireless communication, such as WiFi, Wibro, wireless LAN, Bluetooth, UWB, and the like.

The device search unit 308 searches for a device supporting CPNS, receives device information from the searched device, and manages the device information. Here, the device information includes identification, provided services, codec information, and the like.

That is, the device search unit 308 searches for a device that will function as a PN gateway device in order to use CPNS services.

The display unit 306 displays a list of contents stored in the storage unit 304 and a list of contents processed to be shared by the contents-share processing unit 310. The user may confirm the contents lists displayed on the display unit 306 and request to play back desired contents by selecting the contents.

The contents-share processing unit 310 requests the contents list from the dongle device searched by the device search unit 308 and receives a corresponding contents list through the wireless communication unit 302.

In addition, the contents-share processing unit 310 requests and receives contents corresponding to a contents list selected by the user from the received contents list.

The playback unit 312 plays back the contents shared by the contents-share processing unit 310.

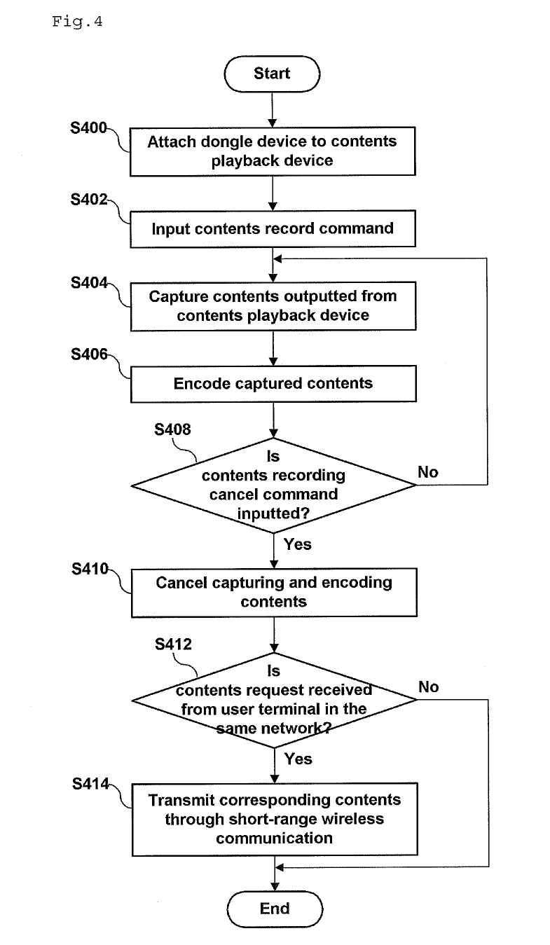

FIG. 4 is a flowchart illustrating a method for providing contents through a network in a device incapable of connecting to a network according to an embodiment of the present invention.

Referring to FIG. 4, the dongle device is attached to the contents playback device through a stereo jack 5400, and if a contents record command is inputted by a user S402, the dongle device captures contents outputted through the audio output port of the contents playback device S404.

For example, if the contents playback device is a radio and the music currently outputted from the radio is desired to be recorded, the user connects the dongle device to the radio through the audio output port of the radio. Next, if the user inputs a contents record command through the input unit provided at the exterior of the dongle device, the dongle device captures contents outputted from the contents playback device.

After perform step S404, the dongle device encodes the captured contents S406. The dongle device stores the encoded contents into the storage unit.

After performing step S406, if the user inputs a contents recording cancel command 5408, the dongle device stops capturing and encoding the contents 5410.

Next, the dongle device determines whether or not download of contents is requested from a user terminal existing in the same network 5412.

That is, the user terminal supports CPNS and searches for a device that will perform short-range wireless communication within the same network.

Then, since there is a wireless communication unit for performing short-range wireless communication, the dongle device transmits its own device information to the user terminal, and the user terminal determines the dongle device as a device that is searched to perform the short-range wireless communication.

Next, the user terminal request and receives a contents list from the dongle device, selects a desired contents list from the received contents list, and requests download of contents corresponding to the selected contents list from the dongle device.

If download of contents is requested from the user terminal as a result of step S412, the dongle device extracts corresponding contents from the storage unit and transmits the contents to the user terminal through the short-range wireless communication network S414.

In addition, since the user terminal and the dongle device share the terminal information with each other, if download of contents is requested from the user terminal, the dongle device determines an encoding format using codec information contained in the terminal information on the user terminal. Next, the user terminal may re-encode corresponding contents depending on the determined encoding format and transmit the re-encoded contents to the user terminal through the short-range wireless communication network.

Through the procedures described above, a contents playback device incapable of connecting to a network is enabled to operate as a device capable of connecting to a network only by attaching a dongle device, and since the dongle device encodes the contents outputted from the contents playback device in real-time and transfers the encoded contents to an external user terminal through the CPNS protocol, the contents can be shared between the contents playback device and the external user terminal.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

A contents playback device incapable of connecting to a network is enabled to operate as a device capable of connecting to a network only by attaching a dongle device, and the dongle device encodes the contents (e.g., sound source data) outputted from the contents playback device in real-time and transfers the encoded contents to an external user terminal through the CPNS protocol. Therefore, the system and method for providing contents through a network in a device incapable of connecting to a network is appropriate when sharing the contents between the contents playback device the external terminal users is highly necessary.

1. A system for providing contents through a network in a device incapable of connecting to a network, the system comprising:
a contents playback device provided with an audio output port, for playing back the contents; and
a dongle device supporting CPNS and attached to the audio output port to enable the contents playback device to operate as a device capable of connecting to a network, for capturing and encoding the contents outputted from the contents playback device and providing an external user terminal with the encoded contents through the network.

2. The system according to claim 1, further comprising a user terminal for requesting download of contents from the dongle device through the CPNS and receiving corresponding contents.

3. The system according to claim 1, wherein the contents playback device operates as a device capable of connecting to a network through a wireless communication unit provided in the dongle device.

4. A dongle device comprising:
a stereo jack interface unit attached to an audio output port of a contents playback device, for communicating with the contents playback device;
a wireless communication unit for performing communication through a short-range wireless communication network;
an input unit for inputting a user command;
a contents capture unit for capturing contents outputted from the contents playback device through the stereo jack interface unit if a contents record command is inputted through the input unit; and
an encoding unit for encoding the contents captured by the contents capture unit.

5. The dongle device according to claim 4, further comprising a contents extracting unit for extracting and transmitting corresponding contents to a user terminal through the wireless communication unit if download of contents is requested from the user terminal existing in the same network.

6. The dongle device according to claim 5, wherein in response to the contents download request received from the user terminal, the encoding unit determines an encoding format based on terminal information on the user terminal, re-encodes corresponding contents depending on the determined encoding format, and transmits the re-encoded contents through the wireless communication unit.

7. The dongle device according to claim 4, wherein if a contents recording cancel command is inputted through the input unit while capturing the contents, the contents capture unit stops capturing the contents.

8. A user terminal comprising:
a wireless communication unit for performing communication through a short-range wireless communication network;
a storage unit for storing contents;
a device search unit for searching for a device supporting CPNS, receiving device information from the searched device, and managing the received device information;
a contents-share processing unit for requesting and receiving a contents list from the device searched by the device search unit, requesting download of contents corresponding to a contents list selected by a user from the received contents list, and receiving contents of the selected contents list; and
a playback unit for playing back the contents shared by the contents-share processing unit.

9. A method for providing contents through a network in a device incapable of connecting to a network, in which a dongle device provides contents stored in a contents playback device incapable of connecting to a network to an external user terminal through the network, the method comprising the steps of:
(a) connecting to the contents playback device through an audio output port provided in the contents playback device;
(b) capturing the contents outputted through the audio output port of the contents playback device if a contents record command is inputted; and
(c) encoding the captured contents.

10. The method according to claim 9, further comprising, after step (c), the step of extracting and transmitting corresponding contents to the user terminal through short-range wireless communication if download of contents is requested from the user terminal existing in the same network.

11. The method according to claim 10, wherein if download of contents is requested from the user terminal, an encoding format is determined based on terminal information on the user terminal, and corresponding contents are re-encoded depending on the determined encoding format and transmitted to the user terminal through the short-range wireless communication.

12. The method according to claim 9, wherein in step (a), the dongle device is attached to the audio output port of the contents playback device to be connected to the contents playback device, and the contents playback device operates as a device capable of connecting to a network through a wireless communication unit provided in the dongle device.

13. The method according to claim 9, wherein in step (b), if a contents recording cancel command is inputted while capturing the contents, capturing the contents is stopped.
